(19) United States
(12) Patent Application Publication
(10) Pub. No.: US 2007/0018019 A1
(43) Pub. Date: Jan. 25, 2007

(54) Spray head for differential delivery of treated water and mains water

(76) Inventor: Fabrizio Nobili, San Vittore (CH)

Correspondence Address: MODIANO & ASSOCIATI, Via Meravigli, 16, Milan, 20123, IT

(21) Appl. No.: 11/485,257

(22) Filed: Jul. 13, 2006

(30) Foreign Application Priority Data
Jul. 21, 2005 (IT) MI2005A001405

(51) Int. Cl. B05B 1/30

(52) U.S. Cl. 239/581.1; 239/548; 239/569

(57) ABSTRACT

A spray head for differential delivery of treated water and mains water comprising, within a containment enclosure, a duct for supplying mains water, which can be connected to a first delivery region, and a duct for supplying treated water, which is connected to a second delivery region and is controlled by a flow control element, which can be operated by means of an actuation element, which can be accessed from the outside of the containment enclosure, the spray head further comprising a meter for metering the amount of dispensed treated water.

The present invention relates to a spray head for the differential delivery of treated water and mains water.

### BACKGROUND OF THE INVENTION

As is known, in many cases it is necessary to have two separate deliveries of water, for example because the mains water does not have the correct values of potability and therefore it is convenient to have a mains water delivery point and a point for delivering water that has already been filtered.

The treated water is sent, before delivery, to a filtration assembly, which can be of any kind, depending on the type of pollutants that may be present in the water.

Obviously, filters require periodic replacements in order to maintain their efficiency, and these replacements are currently performed at preset periods; therefore, a correct maintenance is not performed, since the amount of water that is treated may differ in different periods depending on actual use.

Currently the user does not have an effective means for knowing whether it is necessary to replace the filter, and therefore, in doubt, in many cases filters that are still efficient might be replaced or filters that have become inefficient might not be replaced.

### SUMMARY OF THE INVENTION

The aim of the invention is to solve the problem described above, by providing a spray head for the differential delivery of treated water and mains water that allows to provide the user with a safe element in order to replace the filter only when this is actually necessary.

Within this aim, an object of the invention is to provide a spray head in which the user can have immediately indications as to the current state of the filter, thus being able to provide optimum maintenance.

Another object of the invention is to provide a spray head for differential delivery of treated water and mains water which, thanks to its particular constructive characteristics, is capable of giving the greatest assurances of reliability and safety in use.

Another object of the present invention is to provide a spray head that can be obtained easily starting from commonly commercially available elements and materials and is further competitive from a merely economical standpoint.

This aim and these and other objects, which will become better apparent hereinafter, are achieved by a spray head for differential delivery of treated water and mains water, according to the invention, comprising, within a containment enclosure, a duct for supplying mains water, which can be connected to a first delivery region, and a duct for supplying treated water, which is connected to a second delivery region and is controlled by a flow control element, which can be operated by means of an actuation element, which can be accessed from the outside of said enclosure, characterized in that it comprises means for metering the amount of dispensed treated water.

### BRIEF DESCRIPTION OF THE DRAWINGS

Further characteristics and advantages of the present invention will become better apparent from the description of a preferred but not exclusive embodiment of a spray head for differential delivery of treated water and mains water, illustrated by way of non-limiting example in the accompanying drawings, wherein:

FIG. 1 is a schematic side elevation view of the spray head according to the invention;

FIG. 2 is a side, cross-sectional view of the spray head, with the containment enclosure removed;

FIG. 3 is a schematic perspective view of an embodiment for the telephone-type spray head;

FIG. 4 is a view of an embodiment for a spray head with axial or pull-down delivery.

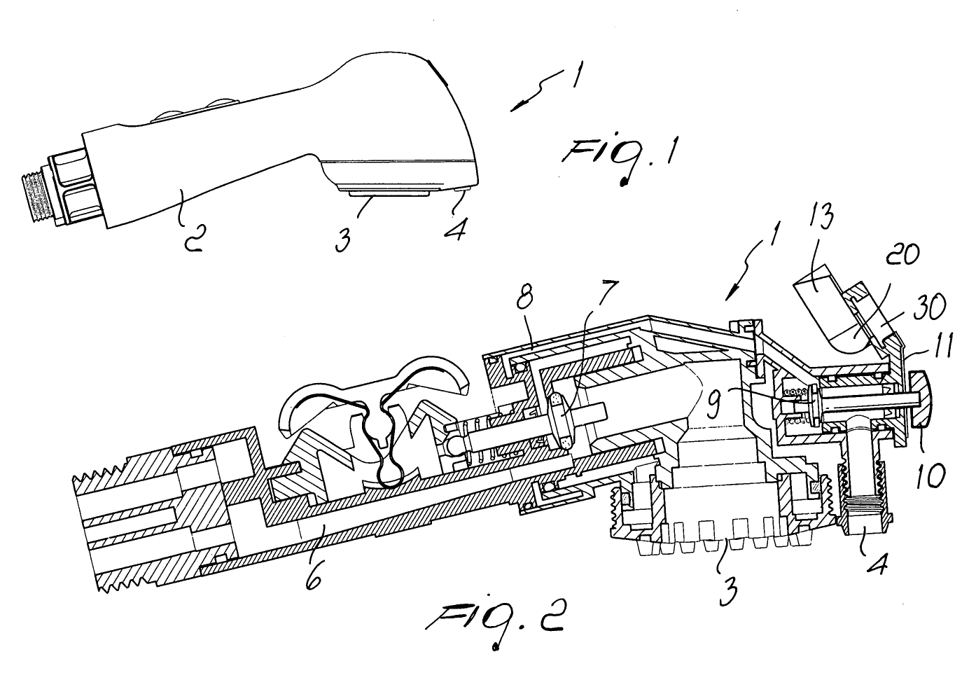

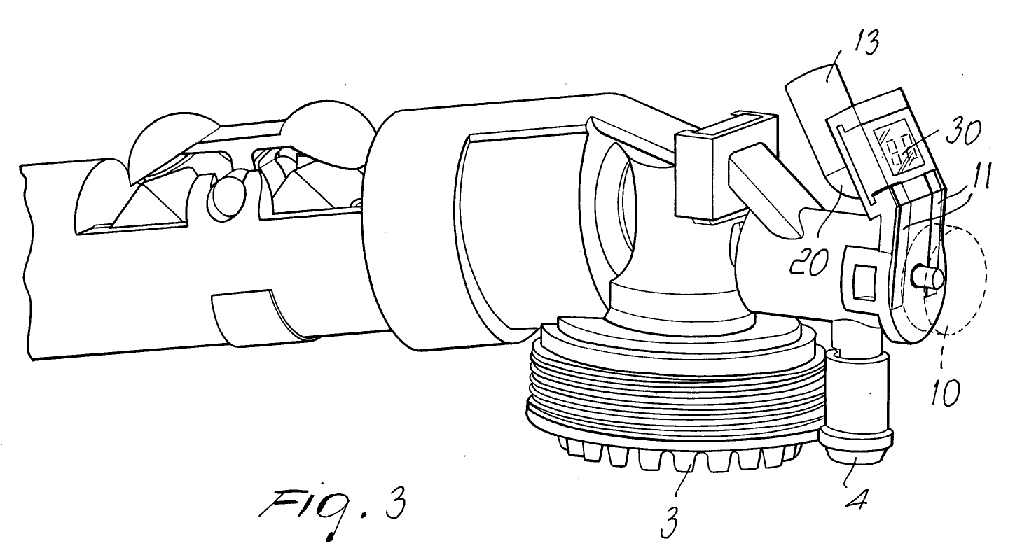

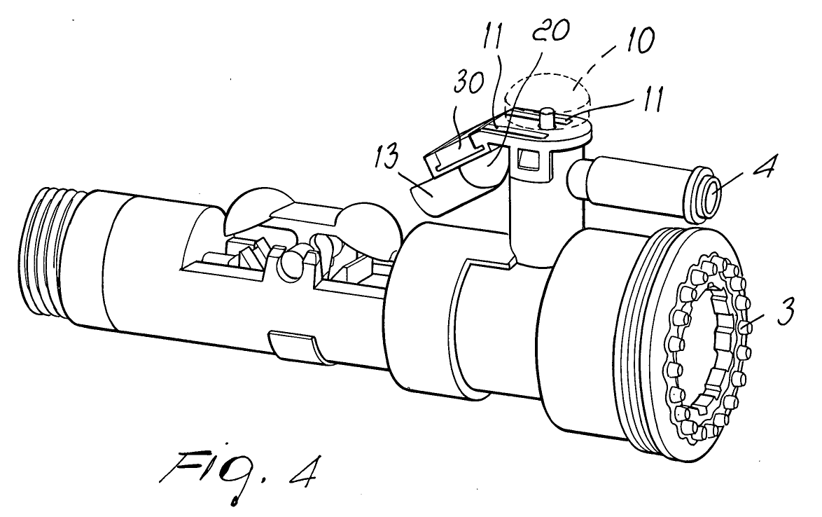

### DESCRIPTION OF THE PREFERRED EMBODIMENTS

With reference to the figures, the spray head for differential delivery of treated water and mains water, according to the invention, generally designated by the reference numeral 1, comprises a containment enclosure 2, which can assume any shape deemed appropriate and forms on its outer surface a delivery point 3 for mains water and a delivery point 4 for treated water.

With reference to the drawings, an embodiment with a telephone-type spray head, in which the points 3 and 4 are arranged side by side at the lower face, and another embodiment, in which the delivery points, again designated by the reference numerals 3 and 4, are in practice formed at the axial end, are described.

Optionally, the delivery point 3 for the mains water may have two or more different types of jet, according to a technology which is common in spray heads of this type.

Within the containment enclosure 2 an ordinary duct 6 is provided for supplying mains water, which is controlled by a shunt valve 7 to obtain different types of jet, and a duct 8 is also provided for supplying treated water, on which a flow control element 9 acts which can be operated by means of a button 10 which can be accessed from the outside of the outer enclosure.

The peculiarity of the invention consists in that there are means for metering the amount of treated water that is dispensed, so as to provide a precise indication as to the need to replace the filters, since in practice the amount of water delivered is clearly indicated and therefore it is possible to perform maintenance at the appropriate times.

The metering means for metering the amount of delivered treated water are constituted by a meter 20, which is integrated within the enclosure, is controlled by means of contacts or similar elements 11, which are operated by the button 10, and is advantageously made of metallic material, so that the meter 20 is activated only when the button 10 is operated, said button starting the metering by means of the contacts 11.

Inside the enclosure a hermetic container is provided, designated by the reference numeral 13, for a battery connected to the power supply circuit of the metering means, and a display 30 is also provided, which is controlled by the meter 20 and can be accessed on the outside of the containment enclosure 2.

With the arrangement described above, it is possible to meter automatically the amount of water that is delivered, and this metering is effectively performed by metering the treated water delivery period, thus having a direct correlation with the amount of water that is delivered.

With the arrangement described above, therefore, an element is provided which gives the user an immediate perception of the need to replace the filters, since the user is always informed as to the amount of water that has been delivered, so that it is possible to replace the filters after a preset period of use.

Obviously it is further possible to reset the meter when the filters are replaced.

From what has been described above, it is evident that the invention achieves the proposed aim and objects, and in particular the fact is stressed that a spray head is provided which allows the user to have always and immediately the perception of the period of operation, thus allowing to optimize the filter maintenance steps.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2005A001405 from which this application claims priority are incorporated herein by reference.

What is claimed is:

1. A spray head for differential delivery of treated water and mains water, comprising a containment enclosure that encloses: a duct for supplying mains water that is connecteable to a first delivery region; a duct for supplying treated water that is connected to a second delivery region; a flow control element for controlling flow in an actuation element for operating said flow control element, said actuation element being accessable from outside said enclosure; and metering means for metering an amount of dispensed treated water.

2. The spray head of claim 1, wherein said metering means for metering the amount of dispensed treated water comprises a meter with controlled contacts which is operatable by said actuation element.

3. The spray head according to claim 2, wherein said metering means are suitable to detect duration of a period of delivery of treated water.

4. The spray head according to claim 2, further comprising a display which is controlled by said meter and is accessable on the outside of said containment enclosure.

5. The spray head of claim 3, further comprising, inside said containment enclosure, a hermetic container for accommodating an electric power source for said metering means.

6. The spray head of claim 5, further comprising resetting means for resetting said metering means upon filter changing.
